(19) United States
(12) Patent Application Publication
(10) Pub. No.: US 2026/0369910 A1
(43) Pub. Date: Nov. 19, 2026

(54) CONNECTION DEVICE FOR INTERNALLY COOLED CABLES

(71) Applicant: LEONI KABEL GMBH, Roth (DE)

(72) Inventor: SEBASTIAN GOSS, ROTH (DE)

(21) Appl. No.: 19/103,297

(22) PCT Filed: Aug. 24, 2023
(86) PCT No.: PCT/EP2023/073213

§ 371 Date: Feb. 12, 2025

(30) Foreign Application Priority Data
Sep. 1, 2022 (DE) 10 2022 122 132.6

(51) Int. Cl. H01R 13/00; H01R 13/512; H01R 13/52; H01R 13/58; H01R 24/66

(52) U.S. Cl. CPC H01R 13/005; H01R 13/512; H01R 13/5216; H01R 13/582; H01R 24/66

(57) ABSTRACT

A connection device for internally cooled cables has a cable-guiding section which is designed to at least partly surround at least one part of a cable including a line for electric current and a coolant line. The connection device additionally has a conductor-guiding section which is designed to at least partly surround at least one part of a line for electric current. The connection device additionally has a coolant-conducting section which is designed to at least partly surround at least one part of the coolant line. The cable-guiding section, the conductor-guiding section and the coolant-conducting section together surround at least one part of the interior of the connection device. Additionally, the cable-guiding section, the conductor-guiding section and the coolant-conducting section are formed together by at least one wall element.

### RELATED APPLICATIONS

This application filed under 35 U.S. C § 371 is a national phase application of International Application Number PCT/EP2023/073213, filed Aug. 24, 2023, which claims the benefit of German Application No. 10 2022 122 132.6 filed Sep. 1, 2022, the subject matter of which are incorporated herein by reference in their entirety.

### TECHNICAL FIELD

There are disclosed herein a connection device for internally cooled cables and a connection system having a connection device and an internally cooled cable.

### BACKGROUND

Internally cooled cables are known that comprise, in addition to one or more conductors for electric current, also one or more coolant lines for the passage of a coolant, in particular a liquid coolant. An example of a cable having such a coolant line and a line for electric current is disclosed by document DE 10 2020 117 588 A1.

An advantage of internally cooled cables is that heat caused by a current flow or by external action can efficiently be dissipated from the cable, so that the electrical resistance of the current-carrying conductor is not increased.

A disadvantage of internally cooled cables is, however, that they are complex to install. To this end, it is necessary first to separate the current-carrying conductor from the coolant line of the cable and then connect the current-carrying conductor and the coolant line, each separately from the other, to a power source and to a coolant supply, respectively. It must here be ensured in particular that the coolant, in particular liquid coolant, cannot come into contact with the current-carrying conductors.

Accordingly, the technical object is to provide an improved connection device for internally cooled cables, which facilitates the connection of the cables to a power source and to a coolant supply and in particular ensures that the current-carrying conductors of the internally cooled cable do not accidentally come into contact with coolant in the region of the connection device.

### SUMMARY

A connection device for internally cooled cables has at least one cable-guiding section, which is adapted to at least partly surround or to receive at least part of a cable having a line for electric current and having a coolant line, in particular a cable end. The connection device further has at least one conductor-guiding section, which is adapted to at least partly surround or to receive at least part of a line for electric current of the internally cooled cable, and a coolant-guiding section, which is adapted to at least partly surround or to receive at least part of a coolant line of the internally cooled cable, in particular a coolant line for a liquid or gaseous coolant. The cable-guiding section and the conductor-guiding section and the coolant-guiding section together at least partly surround at least part of an interior of the connection device.

The cable-guiding section can be adapted in particular to surround or to receive an internally cooled cable and/or cable end having an insulation and/or having a line for electric current and having a coolant line that are in each case not separate from one another and/or are in contact with one another. The conductor-guiding section can be adapted in particular to surround or to receive a line for electric current that is separate from an insulation of the internally cooled cable, which is received or at least partly surrounded by the cable-guiding section, and/or from one or more coolant lines of the internally cooled cable. Furthermore, the coolant-guiding section can be adapted in particular to surround or to receive a coolant line that is separate from an insulation of the internally cooled cable, which is received or at least partly surrounded by the cable-guiding section, and/or from one or more lines for electric current of the internally cooled cable.

The cable-guiding section and the conductor-guiding section and the coolant-guiding section are together formed by at least one wall element. In other words, each wall element of the connection device forms at least part of the cable-guiding section and of the conductor-guiding section and of the coolant-guiding section.

A wall element is a device component that forms at least part of a wall or device outside wall that at least partly surrounds an interior of the connection device and/or separates the interior of the connection device from an outside space around the connection device. A wall element can have openings or be configured without openings.

An advantage of this connection device is that the connection of an internally cooled cable to a power source and to a coolant supply is facilitated, wherein it is ensured in particular that a line for electric current of the internally cooled cable does not accidentally come into contact with coolant in the region of the connection device. It is sufficient to separate a line for electric current of the cable from the coolant line and arrange it in the conductor-guiding section. A coolant line of the cable can be arranged in the coolant-guiding section. The coolant-guiding section and the conductor-guiding section can be sections of the connection device that are separate from one another. The coolant line and the line for electric current are thus guided away from and are separate from one another. At the same time, the cable end arranged in the cable-guiding section, the line for electric current arranged in the conductor-guiding section and the coolant line arranged in the coolant-guiding section can be mechanically fixed and electrically insulated by being received in the connection device. The handleability of the cable end can thus be improved. Furthermore, a connection of the line for electric current to a power source and/or a connection of the coolant line to a coolant supply can thus be improved.

The connection device can comprise two or more wall elements, which together at least partly surround the interior of the connection device and/or which together form the cable-guiding section and the conductor-guiding section and the coolant-guiding section.

In a variant, the connection device can comprise in particular two wall elements which are formed symmetrically to one another and which together at least partly surround the interior of the connection device and/or which together form the cable-guiding section and the conductor-guiding section and the coolant-guiding section. Two wall elements are symmetrical to one another when they are at least substantially, that is to say apart from mutually corresponding fastening devices on the wall elements, point-symmetrical and/or mirror-symmetrical to one another.

An advantage of forming the connection device with multiple, in particular two, wall elements which are symmetrical to one another is that said wall elements can be manufactured efficiently, for example by an injection molding process, in a large number.

A further advantage is that the arrangement of a cable and/or cable end in the connection device is facilitated. If the connection device is formed, for example, by two wall elements, the cable and/or cable end can be arranged or inserted in a first of the wall elements together with the line for electric current and the coolant line, and then a second wall element can be arranged on the first wall element having the cable and/or cable end and the line for electric current and the coolant line, so that the cable and/or cable end is located in the interior of the connection device together with the line for electric current and the coolant line.

The two or more wall elements can in particular be formed in one piece and/or fastened to one another by a hinge element, in particular by a film hinge.

The wall elements can further be configured so as to be pivotable relative to one another about a rotational axis. In other words, the wall elements, which are formed in one piece with one another and/or are fastened to one another, can be moved relative to one another, in particular by pivoting about a rotational or hinge axis.

An advantage of this arrangement is that production efficiency and handleability of the connection device can be further improved.

A further advantage is that the arrangement of a wall element on or at another wall element, on which a cable and/or cable end have previously been arranged together with a line for electric current and a coolant line, can further be facilitated. It is sufficient in this case to pivot or fold the wall elements of the connection device relative to one another in order to arrange the cable and/or cable end in the interior of the connection device together with the line for electric current and the coolant line.

The connection device can further comprise at least one fastening element, which is adapted to fasten the two or more wall elements to one another. The fastening element(s) can be arranged, for example, on one or a plurality of the wall elements. A fastening element can be, for example, a fastening lug, a fastening projection, a latching element, a cable tie, an adhesive element or an adhesive, a rubber, a spring element or a similar element.

An advantage of the fastening element for fastening two wall elements to one another that is integrated in the connection device is that the handleability of the connection device is further improved and the arrangement of a cable and/or cable end, a line for electric current and a coolant line in the interior of the connection device is facilitated.

Alternatively or in addition to the at least one fastening element, the connection device can further comprise at least one centering or positioning aid, which in particular assists with the accurate arrangement of a wall element at or on a further wall element. The at least one centering or positioning aid can be formed, for example, by a material projection and/or a correspondingly shaped material notch in one of the wall elements, which projection and notch engage into one another with positive and/or material engagement, in particular when the wall elements are positioned optimally relative to one another.

The connection device can optionally further comprise a sealing element. The sealing element can be arranged, for example, on a wall element and can be configured to seal an interior of the connection device with respect to environmental influences, in particular with respect to moisture, in particular when a cable and/or cable end has been received by the connection device together with a line for electric current and a coolant line.

The wall element or the wall elements can comprise a production material of plastic, in particular a polymer material.

An advantage of the use of plastics materials is that they electrically insulate the line for electric current and the coolant line. Furthermore, plastics are also suitable for producing wall elements in a large number.

The connection device can optionally comprise a connection element for a coolant line, which connection element is adapted to discharge coolant from a coolant line and/or to introduce coolant into a coolant line. Alternatively or in addition, the connection device can also comprise a contacting device, which is adapted to electrically contact a line for electric current.

An advantage of a connection element for a coolant line that is integrated in the connection device or of a contacting device for a current-carrying conductor of a cable that is integrated in the connection device is that the installation or arrangement of a cable in the connection device is facilitated. At the same time, connection of the connection device to a power source and/or to a coolant supply is facilitated, since the connection elements and/or contacting devices which may be necessary for this purpose are already integrated in the connection device.

In a variant of the connection device, the conductor-guiding section can further be adapted to orient or receive at least part of a line for electric current at an angle of from 45° to 90°, in particular at an angle of 45° or of 90°, relative to a cable that is at least partly surrounded or received by the cable-guiding section and/or relative to a coolant line that is at least partly surrounded or received by the coolant-guiding section. Alternatively or in addition, the coolant-guiding section can be adapted to orient or receive at least part of a coolant line at an angle of from 45° to 90°, in particular at an angle of 45° or of 90°, relative to a cable that is at least partly surrounded or received by the cable-guiding section and/or relative to a line for electric current that is at least partly surrounded or received by the conductor-guiding section.

An advantage of the lines that are guided away from one another at an angle of from 45° to 90° is that a distance between the line for electric current and the coolant line can thus be increased, so that accidental contact of the line for electric current with a coolant is further counteracted.

In a further development, the connection device comprises at least two cable-guiding sections, which are each adapted to at least partly surround or to receive at least part of a cable having a line for electric current and a coolant line, and/or at least two conductor-guiding sections, which are each adapted to at least partly surround or to receive at least part of a line for electric current. Alternatively or in addition, the connection device can also comprise at least a first and a second coolant-guiding section, which are each adapted to at least partly surround or to receive at least part of a coolant line, wherein the first coolant-guiding section is adapted in particular to at least partly surround or to receive a coolant feed line and the second coolant-guiding section is adapted in particular to at least partly surround or to receive a coolant discharge line.

An advantage of a connection device having a plurality of guiding sections for cables, lines for electric current and coolant lines is that the connection device permits the efficient connection of cables or cable assemblies having more than one electrical conductor and/or a plurality of coolant lines, for example having a coolant feed line and having a coolant discharge line.

A connection system for internally cooled cables comprises one of the connection devices for internally cooled cables described above and a cable having a line for electric current and having a coolant line. At least part of the cable is at least partly surrounded or received by the cable-guiding section of the connection device.

Furthermore, at least part of the line for electric current is at least partly surrounded or received by the conductor-guiding section of the connection device, and at least part of the coolant line is at least partly surrounded or received by the coolant-guiding section of the connection device.

At least part of the interior of the connection device can be filled, in particular potted, with a, in particular electrically insulating, filling compound or potting compound.

An advantage of the filling or potting compound is that it can fix the cable and/or the line for electric current and/or the coolant line in the interior of the connection device and/or electrically and/or thermally insulate it.

Further features, properties, advantages and possible modifications will become clear to a person skilled in the art from the following description, in which reference is made to the accompanying figures. In the figures, all the features that are described and/or depicted show the subject matter disclosed herein on their own or in any desired combination.

### BRIEF DESCRIPTION OF THE DRAWINGS

The figures each show connection devices which are suitable for receiving internally cooled cables.

FIG. 1 shows an example of a connection device for an internally cooled cable. FIG. 2 shows an example of wall elements of a connection device for an internally cooled cable.

FIG. 3 shows the arrangement of an internally cooled cable in a wall element of a connection device.

FIG. 4 shows the arrangement of an internally cooled cable in a connection device.

### DETAILED DESCRIPTION

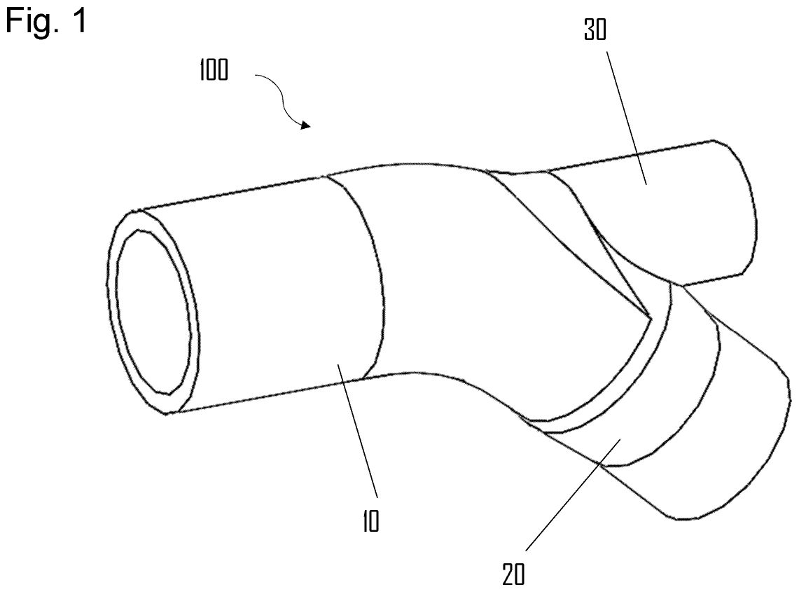

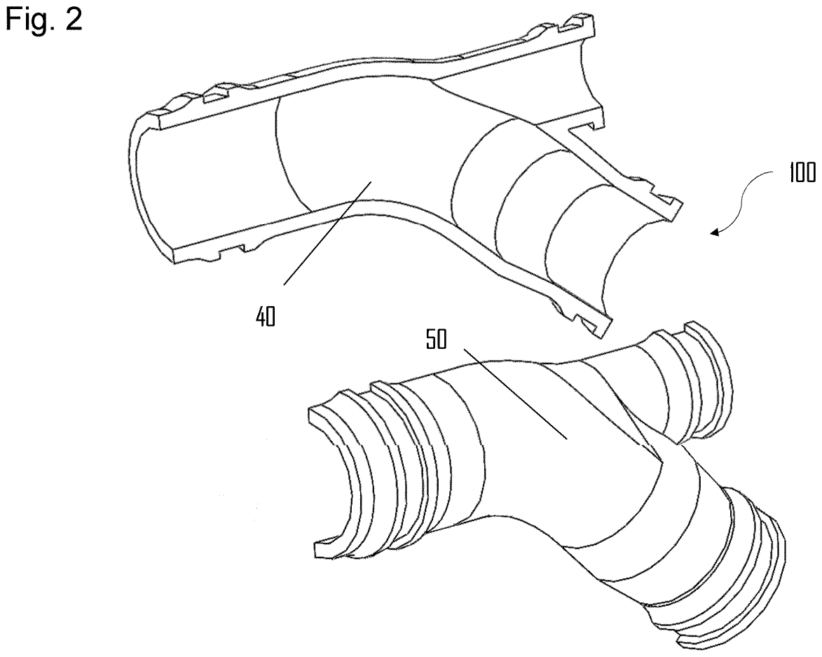

Unless explicitly indicated otherwise, components and parts that correspond or that are comparable in their function are provided with corresponding reference signs in schematic FIGS. 1 to 4.

FIG. 1 shows an example of a connection device 100 having a cable-guiding section 10, which is adapted to receive and to at least partly surround at least part of an internally cooled cable, for example a cable end.

FIG. 1 further shows that the connection device 100 has a conductor-guiding section 20 and a coolant-guiding section 30. The cable-guiding section 10, the conductor-guiding section 20 and the coolant-guiding section 30 together surround the interior of the connection device 100. In other words, the cable-guiding section 10, the conductor-guiding section 20 and the coolant-guiding section 30 together form the connection device 100, which has an interior which, apart from openings for a cable, a coolant line and a line for electric current, is surrounded by wall elements.

The conductor-guiding section 20 shown in FIG. 1 is adapted to receive and to at least partly surround a line for electric current, which is separate from a coolant line of an internally cooled cable. The coolant-guiding section 30 which is likewise shown is adapted to receive and to at least partly surround a coolant line of an internally cooled cable, from which an electrical line of the internally cooled cable has been separated.

The conductor-guiding section 20 and the coolant-guiding section 30 each electrically insulate the respective received and at least partly surrounded lines and guide them away from one another. In the example shown, the lines are guided away from one another at an angle of approximately 45° relative to one another. However, in other embodiments (not shown), the conductor-guiding section 20 and the coolant-guiding section 30 can also guide the respective received lines away from one another at a different angle, for example at an angle of approximately 90°.

The cable-guiding section 10, the conductor-guiding section 20 and the coolant-guiding section 30 each have a circular cross section. However, this is not necessary in all embodiments. In other embodiments (not shown), the cable-guiding section, the conductor-guiding section and/or the coolant-guiding section can also have, for example, an elliptical cross section.

The connection device 100 shown in FIG. 1 comprises two wall elements 40, 50, which are shown in more detail in FIG. 2.

FIG. 2 shows that the two wall elements 40, 50, which together form the cable-guiding section 10, the conductor-guiding section 20 and the coolant-guiding section 30 and which together shape the interior of the cable-guiding device 100, are each formed symmetrically relative to one another.

The two wall elements 40, 50 that are shown can be produced separately from one another and connected together to form the connection device 100 shown in FIG. 1. The wall elements 40, 50 shown in FIG. 2 and the connection device 100 shown in FIG. 1 each comprise for this purpose receiving recesses for fastening elements, said receiving recesses being provided at an end of the cable-guiding section 10, of the conductor-guiding section 20 and of the coolant-guiding section 30. The wall elements 40, 50 can be fixed to one another by fastening elements (not shown in FIGS. 1 and 2) introduced into these receiving recesses.

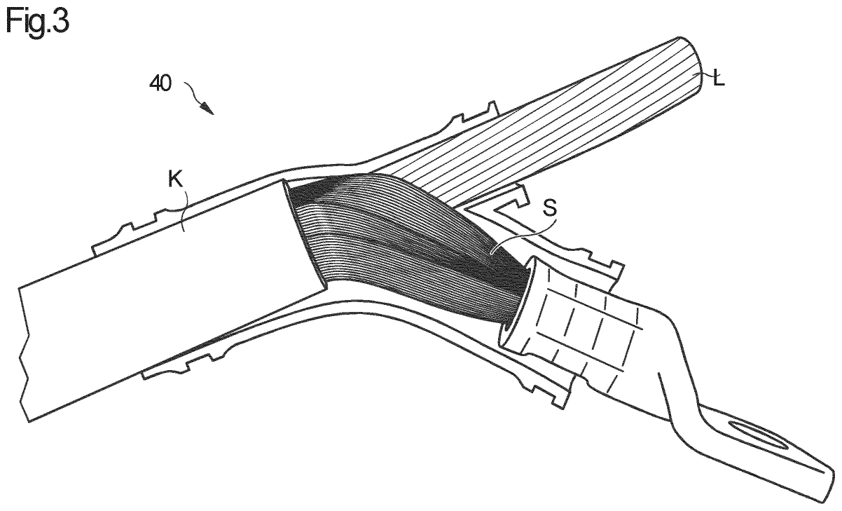

FIG. 3 shows the arrangement of an internally cooled cable K having a line for electric current S and having a coolant line L on a first wall element 40. The insulation has been stripped from the cable K at one cable end, and the cable is arranged at least partly on the wall element 40. The line for electric current S is separate from the coolant line L in the region of the stripped cable K and is likewise arranged on the first wall element 40. The line for electric current S and the coolant line L are each arranged on the sections of the wall element 40 that form the conductor-guiding section 20 and the coolant-guiding section 30 after the first wall element 40 has been connected to a second wall element 50.

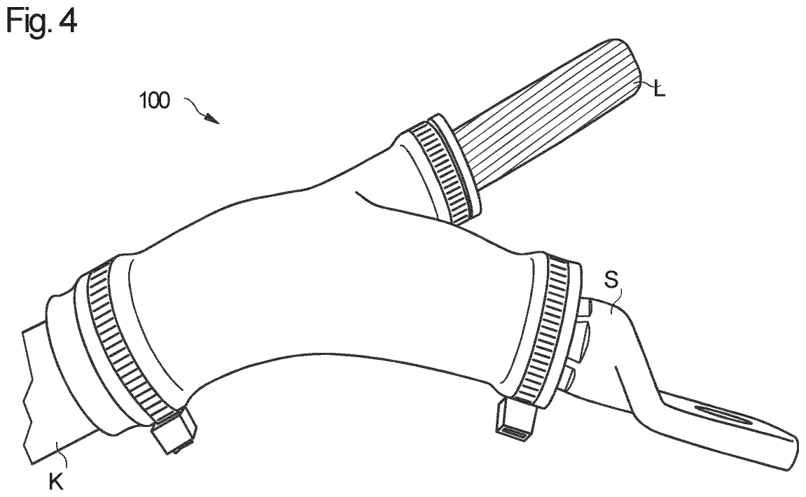

As is shown in FIG. 4, the arrangement shown in FIG. 3, after the second wall element 50 has been fastened to the first wall element 40, forms a connection system for internally cooled cables K having a line for electric current S and having a coolant line L. At least part of the cable K, namely a cable end, is at least partly surrounded by the cable-guiding section 10 of the connection device 100, which comprises the two wall elements 40, 50. At least part of the line for electric current S is at least partly surrounded by the conductor-guiding section 20 of the connection device 100, and at least part of the coolant line L is at least partly surrounded by the coolant-guiding section 30 of the connection device 100.

FIG. 4 further shows that the two wall elements 40, 50 are fixed to one another by fastening elements, which are each arranged in receiving recesses at one end of the cable-guiding section 10, of the conductor-guiding section 20 and of the coolant-guiding section 30.

It will be appreciated that the exemplary embodiments explained above are not exhaustive and do not limit the subject matter disclosed herein. In particular, it will be apparent to the person skilled in the art that he can combine the described features with one another as desired and/or can omit various features without departing from the subject matter disclosed herein.

1. A connection device for internally cooled cables, comprising
a cable-guiding section, which is adapted to at least partly surround at least part of a cable having a line for electric current and having a coolant line, and
a conductor-guiding section, which is adapted to at least partly surround at least part of a-the line for electric current of the cable that is at least partly surrounded by the cable-guiding section, and
a coolant-guiding section, which is adapted to at least partly surround at least part of the coolant line of the cable that is at least partly surrounded by the cable-guiding section, wherein
the cable-guiding section and the conductor-guiding section and the coolant-guiding section together at least partly surround at least part of an interior of the connection device, and wherein
the cable-guiding section and the conductor-guiding section and the coolant-guiding section are together formed by two or more wall elements,
wherein
the wall elements are fastened to one another by a hinge element and are configured so as to be pivotable relative to one another about a rotational axis.

2. (canceled)

3. The connection device as claimed in claim 1, wherein
the connection device comprises two wall elements, which are formed symmetrically to one another and which together at least partly surround the interior of the connection device and/or which together form the cable-guiding section and the conductor-guiding section and the coolant-guiding section

4. (canceled)

5. The connection device as claimed in of the preceding claims 1, wherein
the wall element or the wall elements comprise a production material of plastic, in particular a polymer material.

6. The connection device as claimed in any one claims 1, further comprising
a connection element for the coolant line, which connection element is adapted to discharge coolant from the coolant line and/or to introduce coolant into the coolant line, and/or
a contacting device, which is adapted to electrically contact- the line for electric current, and/or
at least one fastening element, which is adapted to fasten the two or more wall elements to one another.

7. The connection device as claimed in any one of the preceding claims 1, wherein
the conductor-guiding section is further adapted to orient at least part of the line for electric current at an angle of from 45° to 90°, angle of 45° or of 90°, relative to a cable that is at least partly surrounded by the cable-guiding section and/or relative to the coolant line that is at least partly surrounded by the coolant-guiding section, and/or the coolant-guiding section is further adapted to orient at least part of a
the coolant line at an angle of from 45° to 90°, in particular at an angle of 45° or of 90°, relative to a the cable that is at least partly surrounded by the cable-guiding section and/or relative to a the line for electric current that is at least partly surrounded by the conductor-guiding section.

8. The connection device claimed in claims 1, further comprising
at least two cable-guiding sections, which are each adapted to at least partly surround at least part of a cable having a line for electric current and a coolant line, and/or
at least two conductor-guiding sections, which are each adapted to at least partly surround at least part of a line for electric current, and
at least a first and a second coolant-guiding section, which are each adapted to at least partly surround at least part of a coolant line, wherein the first coolant-guiding section is adapted in particular to at least partly surround a coolant feed line and the second coolant-guiding section is adapted in particular to at least partly surround a coolant discharge line.

9. A connection system for internally cooled cables, comprising
a connection device for internally cooled cables as claimed in any one of the preceding claims 1, and
an internally cooled cable having a line for electric current and having a coolant line, wherein
at least part of the cable is at least partly surrounded by the cable-guiding section of the connection device, and wherein
at least part of the line for electric current -is at least partly surrounded by the conductor-guiding section of the connection device, and wherein
at least part of the coolant line is at least partly surrounded by the coolant-guiding section of the connection device.

10. The connection system as claimed in claim 9, wherein
at least part of the interior of the connection device is filled, in particular potted, with a, in particular electrically insulating, filling compound, and/or wherein
the filling compound fixes the cable and/or the line and/or the coolant line -in the interior of the connection device.

11. The connection device as claim in claim 7, wherein
the conductor-guiding section is further adapted to orient at least part of the line for electric current at an angle of 45° or of 90°, relative to a cable that is at least partly surrounded by the cable-guiding section and/or relative to the coolant line that is at least partly surrounded by the coolant-guiding section, and/or
the coolant-guiding section is further adapted to orient at least part of the coolant line at an angle of 45° or of 90° relative to the cable that is at least partly surrounded by the cable-guiding section and/or relative to the line for electric current that is at least partly surrounded by the conductor-guiding section.
